(19) United States
(12) Patent Application Publication
(10) Pub. No.: US 2013/0242537 A1
(43) Pub. Date: Sep. 19, 2013

(54) BULB MOUNTING FIXTURE

(71) Applicant: BEAT-SONIC CO., LTD., Nisshin-shi (JP)

(72) Inventor: Tsutomu TOTANI, Nisshin-shi (JP)

(73) Assignee: Beat-Sonic Co., Ltd., Nisshin-shi (JP)

(21) Appl. No.: 13/772,545

(22) Filed: Feb. 21, 2013

(30) Foreign Application Priority Data
Mar. 13, 2012 (JP) 2012-055220

(51) Int. Cl. F21V 19/00

(52) U.S. Cl. CPC F21V 19/00
USPC 362/95

(57) ABSTRACT

A bulb mounting fixture includes a bulb socket to which a cap of an electrical bulb is attachable and a plug connectable to an electrical outlet. In the bulb mounting fixture, the bulb socket and the plug are configured to be connected to each other by a ball joint.

### CROSS-REFERENCE TO RELATED APPLICATIONS

This application is based upon and claims the benefit of priority from the prior Japanese Patent Application No. 2012-55220 filed on Mar. 13, 2012, the entire contents of which are incorporated herein by reference.

### BACKGROUND

1. Technical Field

The present disclosure relates to a bulb mounting fixture.

2. Related Art

An electrical bulb includes a cap which is generally inserted directly into a power socket fixed to a wall surface or a ceiling, thereby being mounted on the wall surface or the ceiling. A mounting position and/or a direction of the bulb cannot be adjusted when the power socket is fixed to the wall surface or the ceiling. Japanese Patent Application Publication No. JP-A-2011-108608 discloses a bulb mounting fixture which has two ends and includes a plug which is mounted on one end thereof and is connectable to an electrical outlet fixed to a ceiling and an illumination shade which is mounted on the other end thereof and has an incorporated bulb socket. According to the disclosed bulb mounting fixture, when the plug is connected to a ceiling outlet on the ceiling, the bulb attached to the bulb socket in the shade can be hung on the outlet on the ceiling.

The bulb hung down from the bulb mounting fixture of the above-described type is directed only directly downward, and the direction of the bulb is unadjustable. Furthermore, a height position of the bulb depends upon the length of a cord and cannot be adjusted.

### SUMMARY

Therefore, an object of the disclosure is to provide a bulb mounting fixture which can adjust the mounting position and the direction of the bulb.

The present disclosure provides a bulb mounting fixture comprising a bulb socket to which a cap of an electrical bulb is attachable and a plug connectable to an electrical outlet. In the fixture, the bulb socket and the plug are configured to be connected to each other by a ball joint.

The plug is inserted into the electrical outlet thereby to be connected to the electrical outlet. An electrical bulb is then attached to the bulb socket in use. According to the above-described configuration, the bulb socket and the plug are connected to each other by the ball joint. Consequently, the bulb attached to the bulb socket can be adjusted to any direction.

The disclosure also provides a bulb mounting fixture comprising a bulb socket to which a cap of an electrical bulb is attachable and a cap attachable to a power socket. In the fixture, the bulb socket and the cap are configured to be connected to each other by a ball joint.

The cap is screwed into the power socket fixed to the ceiling or the wall surface thereby to be connected to the power outlet. An electrical bulb is then attached to the bulb socket in use. According to the above-described configuration, the bulb socket and the cap are connected to each other by the ball joint. Consequently, the bulb attached to the bulb socket can be adjusted to any direction.

The disclosure further provides a bulb mounting fixture comprising a bulb socket to which a cap of an electrical bulb is attachable, a plug connectable to an electrical outlet, and a joint piece. In the fixture, the bulb socket has a bottom formed with either a first male joint having a substantially spherical head and a through hole extending through a central part of the head or a first female joint having a substantially semispherical hollow portion and a through hole communicating with the hollow portion. The plug has a bottom formed with either the first female joint or the first male joint. The joint piece is provided with a second male joint which has a substantially spherical head and a through hole extending through a central part of the head and a second female joint formed integrally on an end of the second male joint located opposite the head and having a substantially semispherical hollow portion which is formed therein so as to communicate with the through hole. The head of the first male thread joint of either the bulb socket or the plug is slidably fitted in the hollow portion of the second female joint of the joint piece, and the head of the second male joint of the joint piece is slidably fitted in the hollow portion of the first female joint of the plug or the bulb socket, whereby the bulb socket and the plug are connected to each other. Two conductor wires are inserted through the through holes of the first male and female joints of the bulb socket or the plug and the through hole of the second female joint of the joint niece so that the bulb socket and the plug are electrically connected to each other.

In use of the above-described bulb mounting fixture, the plug is inserted into the electrical outlet fixed to the ceiling or the wall surface, and an electrical bulb is attached to the bulb socket. According to the above-described bulb mounting fixture, the head of the bulb socket or the first male joint of the plug is slidably fitted into the hollow portion of the second female joint of the joint piece. The head of the second male joint of the joint piece is slidably fitted into the hollow portion of the first female joint of the plug or the bulb socket, whereby the bulb socket and the plug are connected to each other. Consequently, the bulb attached to the bulb socket can be adjusted to any direction.

The disclosure further provides a bulb mounting fixture comprising a bulb socket to which a cap of an electrical bulb is attachable, a cap attachable to a power socket and a joint piece. In the fixture, the bulb socket has a bottom formed with a first male joint having a substantially spherical head and a through hole formed through a central part of the head or a first female joint having a substantially semi spherical hollow portion and a through hole communicating with the hollow portion. The cap has a bottom formed with the first male or female joint. The joint piece is provided with a second male joint which has a substantially spherical head and a through hole extending through a central part of the head and a second female joint formed integrally on an end of the second male joint located opposite the head and having a substantially semispherical hollow portion which is formed therein so as to communicate with the through hole. The head of the first male thread joint of either the bulb socket or the cap is slidably fitted in the hollow portion of the second female joint of the joint piece, and the head of the second male joint of the joint piece is slidably fitted in the hollow portion of the first female joint of the plug or the bulb socket, whereby the bulb socket and the cap are connected to each other. Two conductor wires are inserted through the respective through holes of the first male and female joints of the bulb socket or the cap and the through hole of the second female joint of the joint piece so that the bulb socket and the cap are electrically connected to each other.

In use of the above-described bulb mounting fixture, the cap is inserted into the power socket fixed to the ceiling or the wall surface, and an electrical bulb is attached to the bulb socket. According to the above-described bulb mounting fixture, the head of the bulb socket or the first male joint of the cap is slidably fitted into the hollow portion of the second female joint of the joint piece. The head of the second male joint of the joint piece is slidably fitted into the hollow portion of the first female joint of the cap or the bulb socket, whereby the bulb socket and the cap are connected to each other. Consequently, the bulb attached to the bulb socket can be adjusted to any direction.

### BRIEF DESCRIPTION OF THE DRAWINGS

In the accompanying drawings:

FIG. 1 is a perspective view of a bulb mounting fixture according to a first embodiment;

FIG. 2 is a cross-sectional view of the bulb mounting fixture according to the first embodiment;

FIG. 3 shows a usage example of the bulb mounting fixture according to the first embodiment;

FIG. 4 is a perspective view of a bulb mounting fixture according to a second embodiment;

FIG. 5 is a cross-sectional view of the bulb mounting fixture according to the second embodiment;

FIG. 6 shows a usage example of the bulb mounting fixture according to the second embodiment;

FIG. 7 is a cross-sectional view of the bulb mounting fixture according to a third embodiment;

FIG. 8 shows a usage example of the bulb mounting fixture according to the third embodiment;

FIG. 9 is a cross-sectional view of the bulb mounting fixture according to a fourth embodiment;

FIG. 10 is a cross-sectional view of a female joint of the bulb mounting fixture according to the fourth embodiment;

FIG. 11 is a cross-sectional view of a male joint of the bulb mounting fixture according to the fourth embodiment;

FIG. 12 is a cross-sectional view of a joint piece of the bulb mounting fixture according to the fourth embodiment;

FIG. 13 is a cross-sectional view of a bulb mounting fixture according to a fifth embodiment;

FIG. 14 is a perspective view of a bulb mounting fixture according to a sixth embodiment;

FIG. 15 is a cross-sectional view of a bulb mounting fixture according to the sixth embodiment;

FIG. 16 shows a usage example of the bulb mounting fixture according to the sixth embodiment;

FIG. 17 is a perspective view of a bulb mounting fixture according to a seventh embodiment;

FIG. 18 is a cross-sectional view of the bulb mounting fixture according to the seventh embodiment;

FIG. 19 shows a usage example of the bulb mounting fixture according to the seventh embodiment;

FIG. 20 is a perspective view of a bulb mounting fixture according to an eighth embodiment;

FIG. 21 is a cross-sectional view of the bulb mounting fixture according to the eighth embodiment;

FIG. 22 shows a usage example of the bulb mounting fixture according to the eighth embodiment;

FIG. 23 is a perspective view of a bulb mounting fixture according to a ninth embodiment;

FIG. 24 is a perspective view of a bulb mounting fixture according to a tenth embodiment; and

FIG. 25 is a perspective view of a bulb mounting fixture according to an eleventh embodiment.

### DETAILED DESCRIPTION

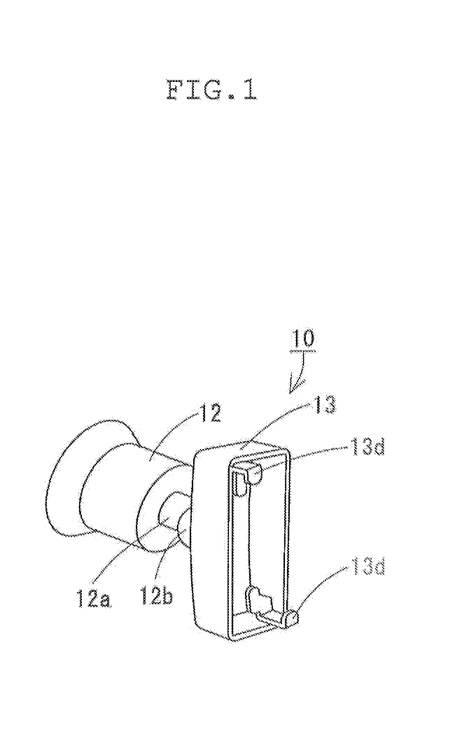

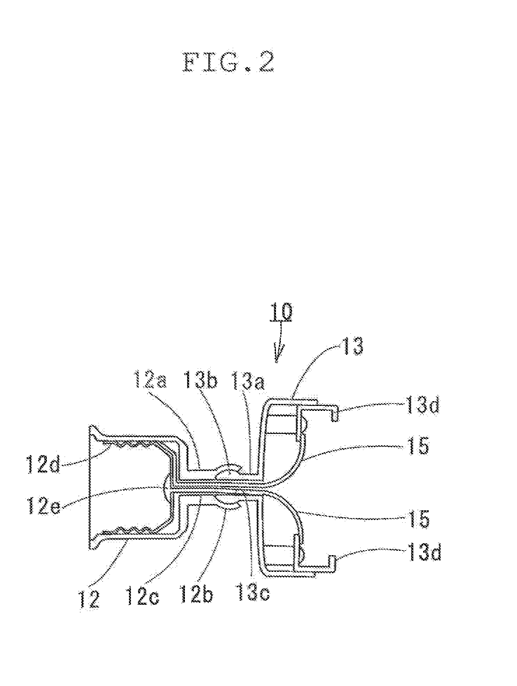

Embodiments will be described with reference to the accompanying drawings. FIGS. 1 to 3 illustrate a bulb mounting fixture 10 according to a first embodiment. The bulb mounting fixture 10 includes a bulb socket 12 to which a cap of an electrical bulb is to be attached and a plug 13 which is to be detachably connected to a ceiling outlet fixed to a ceiling.

The bulb socket 12 has a bottom with a female joint 12a formed integrally therewith. The female joint 12a is formed with a [symbol] substantially semispherical hollow portion 12b and a through hole 12c communicating between the hollow portion 12b and an interior of the bulb socket 12. The plug 13 has a bottom with a male joint 13a formed integrally therewith. The male joint 13a is formed with a substantially spherical head 13b and a through hole 13c extending through the head 13b. The hole 13c is configured to communicate with the hole 12c as will be described later.

The head 13b of the male joint 13a of the plug 13 is slidably fitted into the hollow portion 12b of the female joint 12a of the bulb socket 12, whereby the bulb socket 12 and the plug 13 are connected to each other. Two conductor wires 15 are inserted through the holes 12c and 13c. One of the conductor wires 15 has one end connected to an electrode fitting 12d of the bulb socket 12 and the other conductor wire 15 also has one end connected to an electrode fitting 12e of the bulb socket 12. The other ends of the conductor wires 15 are connected to electrode fittings 13d of the plug 13 respectively.

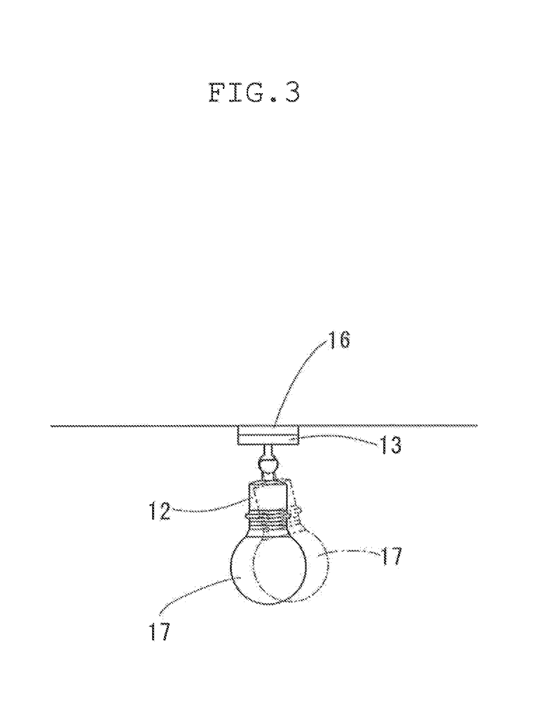

In use of the bulb mounting fixture 10 having the above-described structure, the plug 13 is hung on the ceiling outlet 16 fixed to the ceiling and an electrical bulb 17 is attached to the bulb socket 12, as shown in FIG. 3.

According to the bulb mounting fixture 10, the head 13b of the male joint 13a is slidably fitted into the hollow portion 12b of the female joint 12a, whereby the ball joint is constructed. The bulb socket 12 and the plug 13 are connected to each other by the ball joint. Consequently, the bulb 17 attached to the bulb socket 12 can be adjusted to any direction.

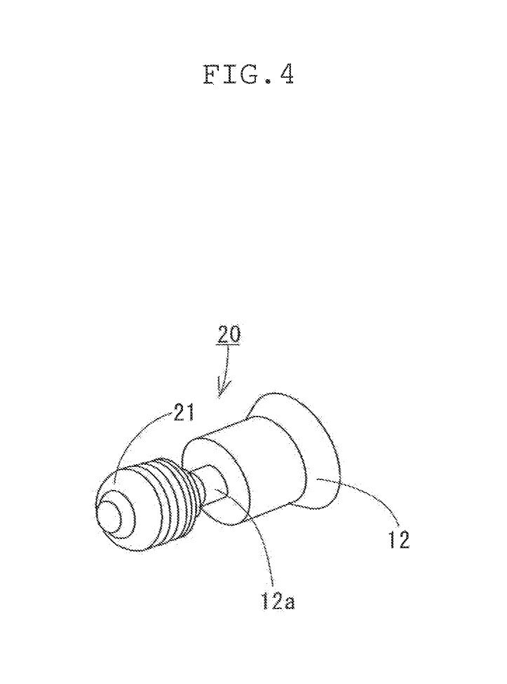

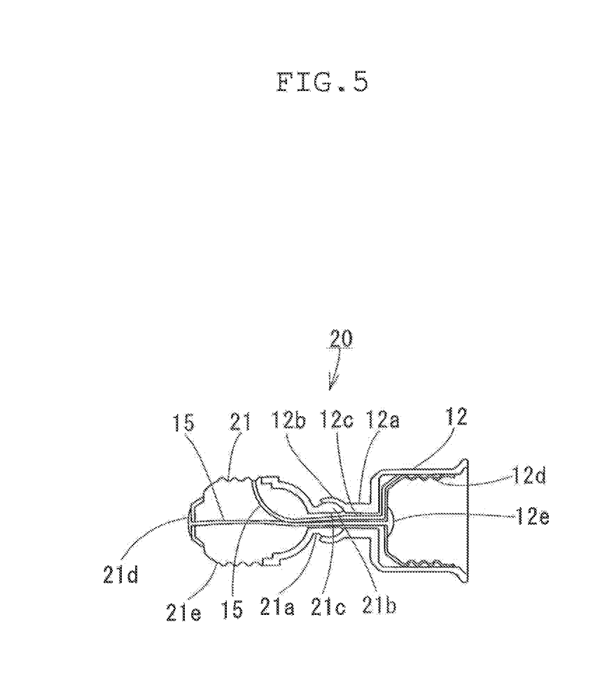

FIGS. 4 to 6 illustrate a bulb mounting fixture 20 according to a second embodiment. The bulb mounting fixture 20 includes the bulb socket 12 and a cap 21 screwed into a power socket 22 fixed to the ceiling or wall surface. The cap 21 has a bottom with a male joint 21a formed integrally therewith. The male joint 21a is formed with a substantially spherical head 21b and a through hole 21c which extends through the head 21b and communicates with an interior of the cap 21. Since the bulb socket 12 has the same structure as the bulb socket 12 employed in the first embodiment, identical or similar parts in the second embodiment are labeled by the same reference symbols as those in the first embodiment, and the description of these parts will be eliminated.

The head 21b of the male joint 21a formed on the cap 21 is slidably fitted into the hollow portion 12b of the female joint 12a formed on the bulb socket 12, whereby the bulb socket 12 and the cap 21 are connected to each other. Two conductor wires 15 are inserted through the hole 12c of the female joint 12a and the hole 21c of the male joint 21a. One of the conductor wires 15 has one end connected to the electrode fitting 12d of the bulb socket 12 and the other conductor wire 15 also has one end connected to an electrode fitting 12e of the bulb socket 12. The other ends of the conductor wires 15 are connected to electrode fittings 21d and 21e of the cap 21 respectively.

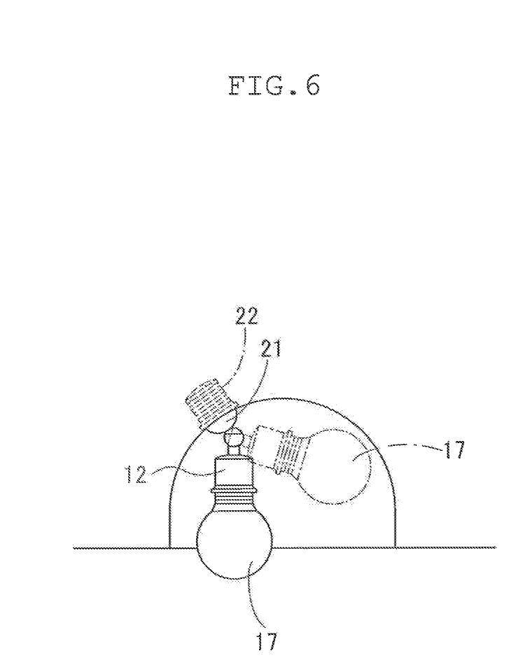

In use of the bulb mounting fixture 20 having the above-described structure, the cap 21 is screwed into the power socket 22 fixed to the ceiling and an electrical bulb 17 is attached to the bulb socket 12, as shown in FIG. 6.

According to the bulb mounting fixture 20, the head 21b of the male joint 21a is slidably fitted into the hollow portion 12b of the female joint 12a, whereby the ball joint is constructed. The bulb socket 12 and the cap 21 are connected to each other by the ball joint. Consequently, the bulb 17 attached to the bulb socket 12 can be adjusted to any direction.

In the bulb mounting fixture 20 according to the second embodiment, the cap 21 has the same size standard as the bulb socket 12 in the bulb mounting fixture 20 according to the second embodiment. However, the bulb socket 12 and the cap 21 may have respective size standards different from each other. In this case, for example, an electrical bulb provided with the cap having the size standard different from that of the power socket 22 can electrically be connected to the power socket 22.

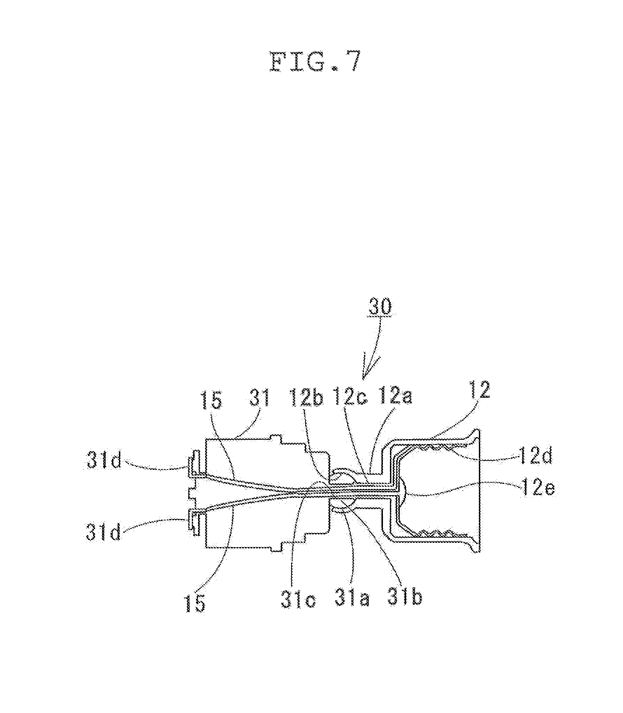

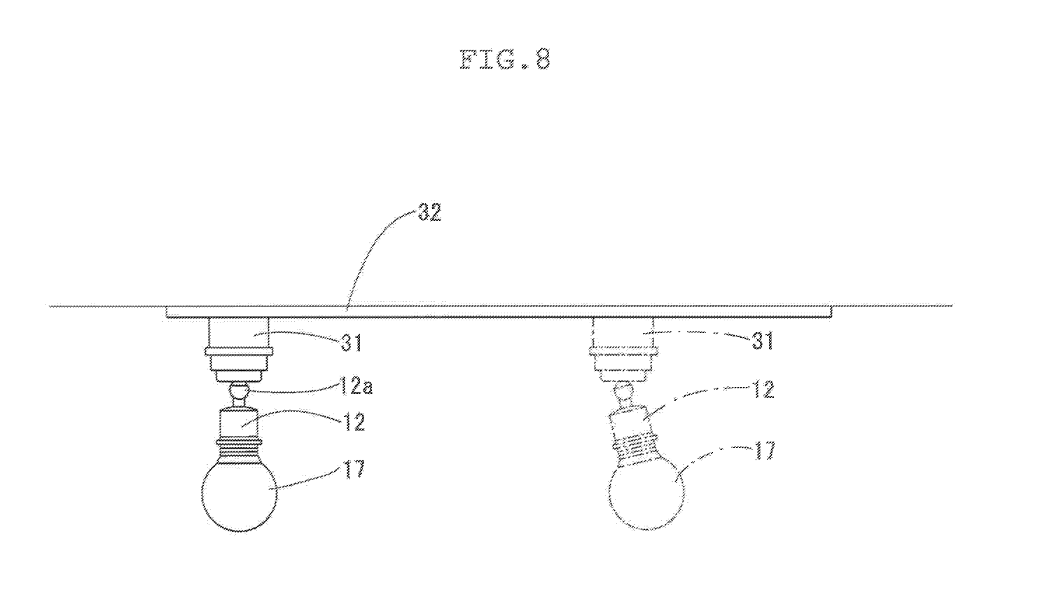

FIGS. 7 and 8 illustrate a bulb mounting fixture 30 according to a third embodiment. The bulb mounting fixture 30 includes the bulb socket 12 and a plug 31 which is configured to be connected to a lighting bar fixed to the ceiling. The plug 31 has a bottom with a male joint 31a formed integrally therewith. The male joint 31a is formed with a substantially spherical head 31b and a through hole 31c which extends through the head 31b and communicates with an interior of the plug 31. The plug 31 has an end surface to which a pair of electrode fittings 31d are fixed. The electrode fittings 31d are slidably hung on rail-like terminals built in the lighting bar. Since the bulb socket 12 has the same structure as the bulb socket 12 employed in the first embodiment, identical or similar parts in the second embodiment are labeled by the same reference symbols as those in the first embodiment, and the description of these parts will be eliminated.

The head 31b of the male joint 31a formed on the plug 31 is slidably fitted into the hollow portion 12b of the female joint 12a formed on the bulb socket 12, whereby the bulb socket 12 and the plug 31 are connected to each other. Two conductor wires 15 are inserted through the hole 12c of the female joint 12a and the hole 31c of the male joint 31a. One of the conductor wires 15 has one end connected to the electrode fitting 12d of the bulb socket 12 and the other conductor wire 15 also has one end connected to an electrode fitting 12e of the bulb socket 12. The other ends of the conductor wires 15 are connected to electrode fittings 31d of the plug 31 respectively.

In use of the bulb mounting fixture 30 having the above-described structure, the plug 31 is connected to the lighting bar 32 and an electrical bulb 17 is attached to the bulb socket 12, as shown in FIG. 8. According to the bulb mounting fixture 30, a position of the bulb 17 hung on the lighting bar 32 can be changed along the lighting bar 32.

Furthermore, the head 31b of the male joint 31a is slidably fitted into the hollow portion 12b of the female joint 12a, whereby the ball joint is constructed. The bulb socket 12 and the plug 31 are connected to each other by the bail join. Consequently, the bulb 17 attached to the bulb socket 12 can be adjusted to any direction.

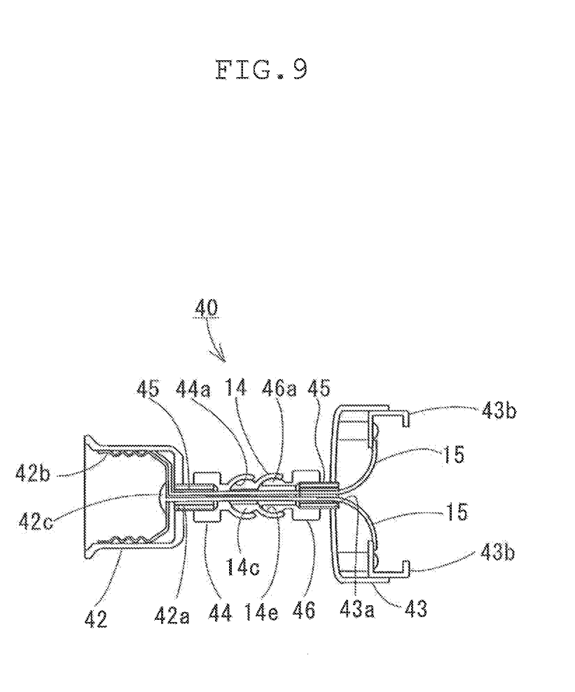

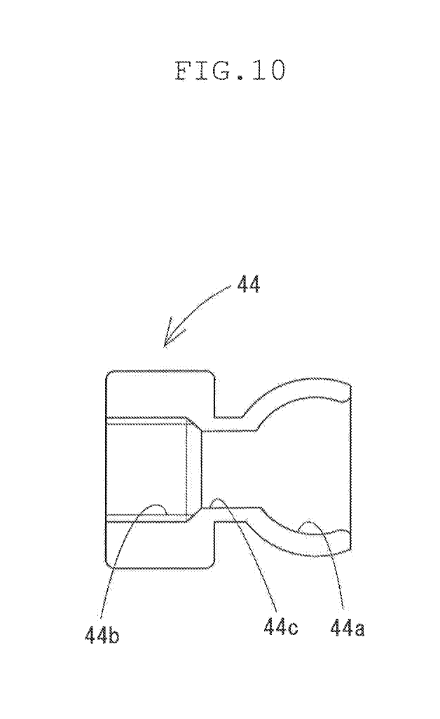

FIGS. 9 to 12 illustrate a bulb mounting fixture 40 according to a fourth embodiment. The bulb mounting fixture 40 includes a bulb socket 42 and a plug 43 and a joint piece 14. The bulb socket 42 has a bottom to which are mounted a female joint 44 and a hollow bolt 45. The female joint 44 is formed with a semispherical hollow portion 44a, a screw hole 44b and a through hole 44c which communicates between the hollow portion 44a and the hole 44b as shown in FIG. 10. On the other hand, the bulb socket 42 has a bottom with a centrally located screw hole 42a. The hollow bolt 45 has one end screwed into the screw hole 42a of the bulb socket 42. The female joint 44 is screwed into the other end of the hollow bolt 45.

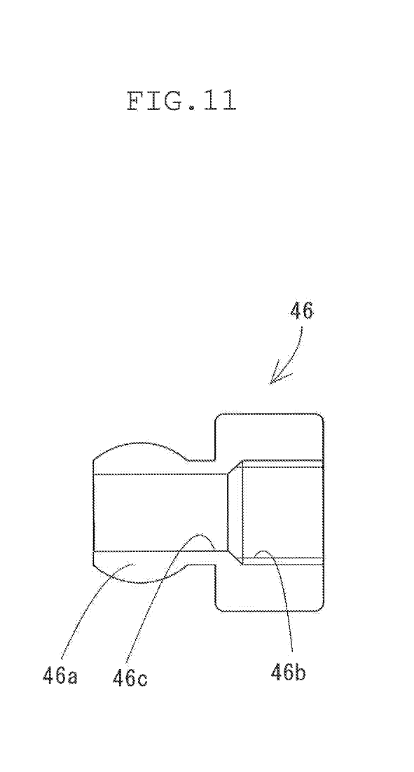

The plug 43 has a bottom to which a male joint 46 and the hollow bolt 45 are mounted. The male joint 46 includes a substantially spherical head 46a, a screw hole 46b and a through hole 46c communicating between the head 46a and the screw hole 46b as shown in FIG. 11. The bottom of the plug 43 has a centrally located screw hole 43a. Another hollow bolt 45 has one end screwed into a screw hole 43a. The female joint 44 is screwed into the other end of the hollow bolt 45.

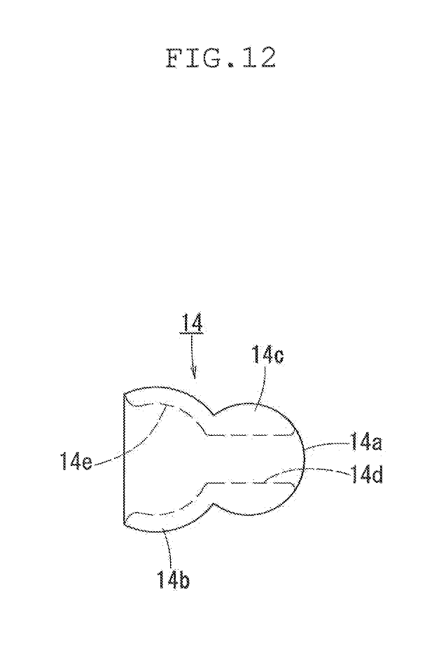

The joint piece 14 is a plastic molding and includes a male joint 14a and a female joint 14b both of which are formed integrally with each other, as shown in FIG. 12. The male joint 14a has a substantially spherical head 14c which is formed with a centrally located through hole 14d. The female joint 14b has a substantially semispherical hollow portion 14e which is integrally formed in one end located opposite the head 14c and communicates with the hole 14d.

The head 14c of the male joint 14a of the joint piece 14 is slidably fitted into the hollow portion 44a of the female joint 44 of the bulb socket 42, and the head 46a of the male joint 46 is slidably fitted into the hollow portion 14e of the female joint 14b of the joint piece 14. The conductor wires 15 are inserted through the hole 44c of the female joint 44 of the bulb socket 44, the hole 14d of the joint piece 14 and the hole 46c of the male joint 46 of the plug 43. One conductor wire 15 has one end connected to the electrode fitting 42b of the bulb socket 42, and the other conductor wire 15 has one end connected to the electrode fitting 42c of the bulb socket 42. The other ends of the conductor wires 15 are connected to the electrode fittings 43b of the plug 43 respectively.

In use of the bulb mounting fixture 40 having the above-described structure, the plug 43 is inserted into the ceiling outlet 16 thereby to be connected to the ceiling outlet 16 and the bulb 17 is attached to the bulb socket 42.

According to the bulb mounting fixture 40, the head 14c of the male joint 14a of the joint piece 14 is slidably fitted into the hollow portion 44a of the female joint 44, and the head 46a of the male joint 46 is slidably fitted into the hollow portion 14e of the female joint 14b of the joint piece 14, whereby the bail joint is constructed. The bulb socket 42 and the plug 43 are connected to each other by the ball joint. Consequently, the bulb 17 attached to the bulb socket 42 can be adjusted to any direction.

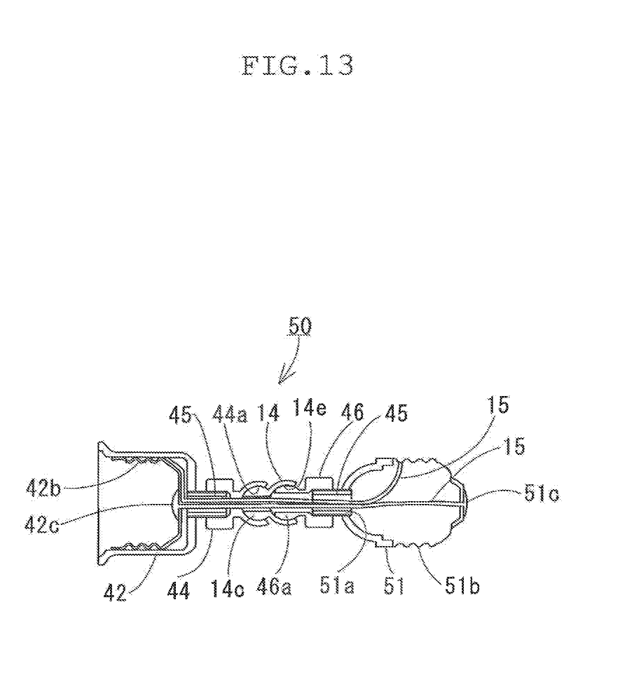

FIG. 13 illustrates a bulb mounting fixture 50 according to a fifth embodiment. The bulb mounting fixture 50 includes the bulb socket 42, a cap 51 screwed into the power socket 22 thereby to be attached to the power socket 22, and the joint piece 14. The cap 51 has a bottom formed with a screw hole 51a. The hollow bolt 45 has one end screwed into the screw hole 51a, and the male joint 46 is screwed into the other end of hollow bolt 45.

The head 14c of the male joint 14a is slidably fitted into the hollow portion 44a of the female joint 44 of the bulb socket 42, and the head 46a of the male joint 46 of the cap 51 is slidably fitted into the hollow portion of the female joint 14b of the joint piece 14. The conductor wires 15 are inserted through the hole 44c of female joint 44, the hole 14d of the joint piece 14 and the hole 46c of the male joint 46. As a result, the ends of the conductor wires 15 are connected to the electrode fittings 42b and 42c of the bulb socket 42, and the other ends of the conductor wires 15 are connected to the electrode fittings 51b and 51c of the cap 51.

In use of the bulb mounting fixture 50 having the above-described structure, the cap 51 is connected to the power socket 22 and an electrical bulb 17 is attached to the bulb socket 42. According to the bulb mounting fixture 50, the female joint 44, the joint piece 14 and the male joint 46 constitute the ball joint. Since the bulb socket 42 and the cap 51 are connected to each other by the above-described ball joint, the bulb 17 attached to the bulb socket 42 can be adjusted to any direction.

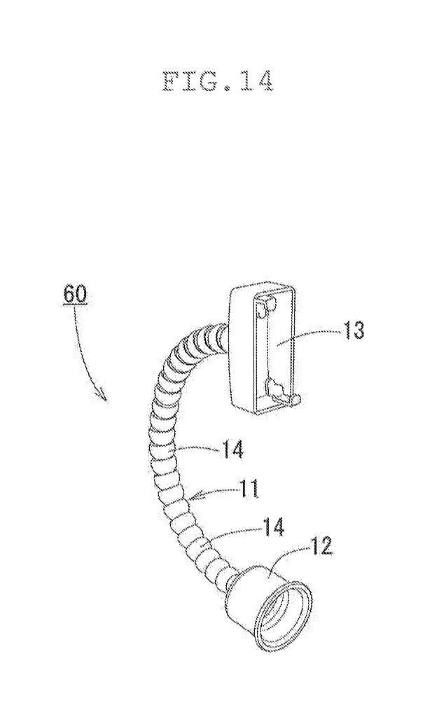

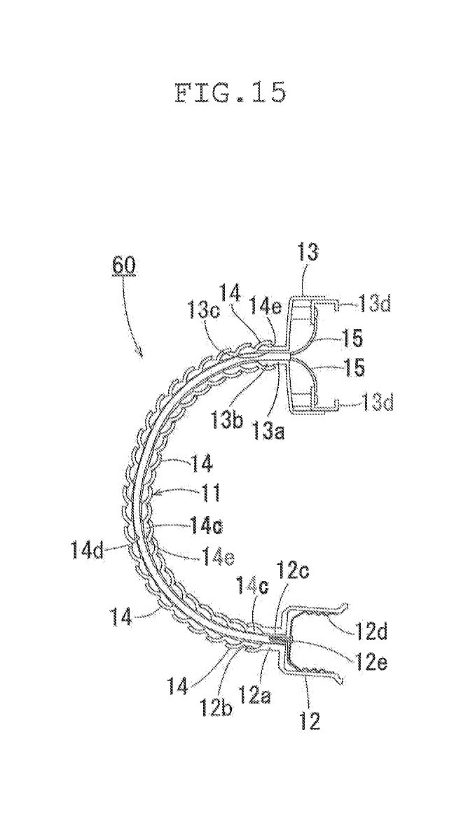

FIGS. 14 to 16 illustrate a bulb mounting fixture 60 according to a sixth embodiment. The bulb mounting fixture 60 includes the bulb socket 12, the plug 13 and the electrical cord body 11. The cord body 11 includes a plurality of joint pieces 14. The male joint 14a of one of the joint piece has the head 14c which is slidably fitted into the hollow portion 14e of the female joint 14b of another joint piece 14, so that the plural joint pieces 14 are connected to one another. The conductor wires 15 are inserted through the holes 14d of the connected joint pieces 14, whereby the cord body 11 connecting the bulb sockets 12 and the plugs 13 to each other is constructed.

The head 14c of the male joint 14a of the joint piece 14 constituting one end of the cord body 11 is slidably fitted into the hollow portion 12b of the female joint 12a of the bulb socket 12. The head 13b of the male joint 13a of the plug 13 is slidably fitted into the hollow portion 14e of the female joint 14b of the joint piece 14 constituting the other end of the cord body 11. The bulb mounting fixture 60 has the other structure that is the same as that of the bulb mounting fixture 10 according to the first embodiment.

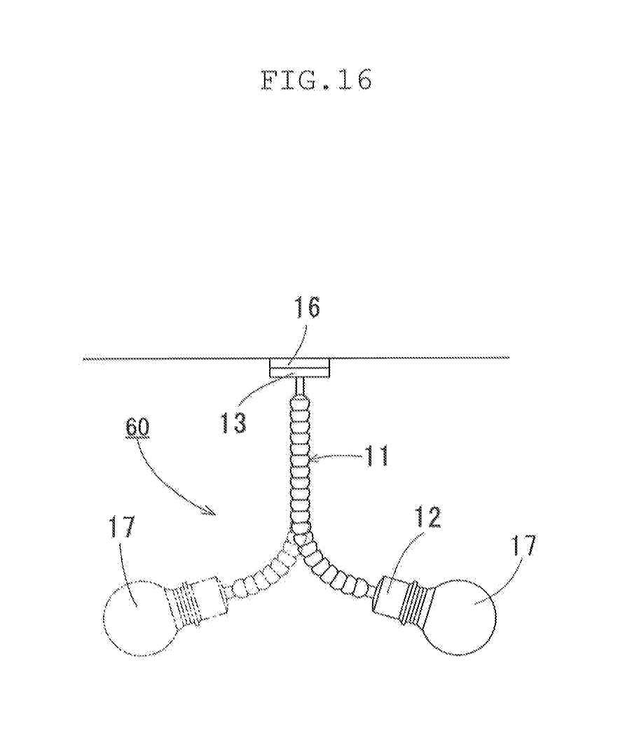

In use of the bulb mounting fixture 60 having the above-described structure, the plug 13 is hung on the ceiling outlet 16 fixed to the ceiling, and the bulb 17 is attached to the bulb socket 17, as shown in FIG. 16. As a result, the bulb 17 is hung down from the ceiling outlet 16 by the cord body 11. According to the bulb mounting fixture 60, the plural joint pieces 14 are slidably connected to one another thereby to be formed into the cord body 11. Consequently, the cord body 11 has flexibility thereby to be flexed. Furthermore, the bulb mounting fixture 60 can be retained in the flexed state of the cord body 11 by a frictional force between the adjacent joint pieces 14. Accordingly, When the cord body 11 is flexed, the bulb 17 attached to the bulb socket 12 mounted on one end of the cord body 11 can be adjusted in the direction and the height position.

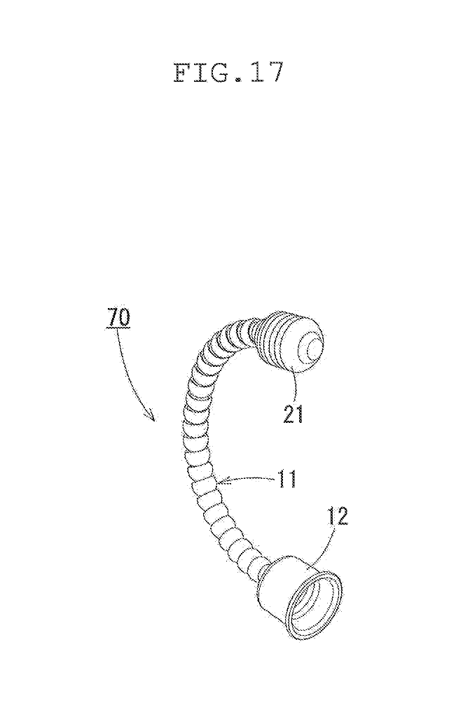

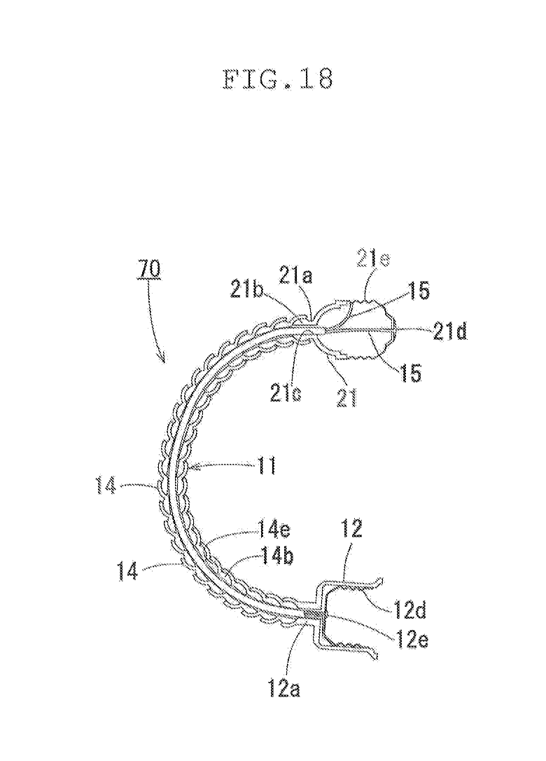

FIGS. 17 to 19 illustrate a bulb mounting fixture 70 according to a seventh embodiment. In the bulb mounting fixture 70, the bulb socket 12 is connected to one end of the cord body 11 and the cap 21 is connected to the other end of the cord body 11. The bulb mounting fixture 70 has the other structure that is the same as that of the bulb mounting fixture 20 according to the second embodiment.

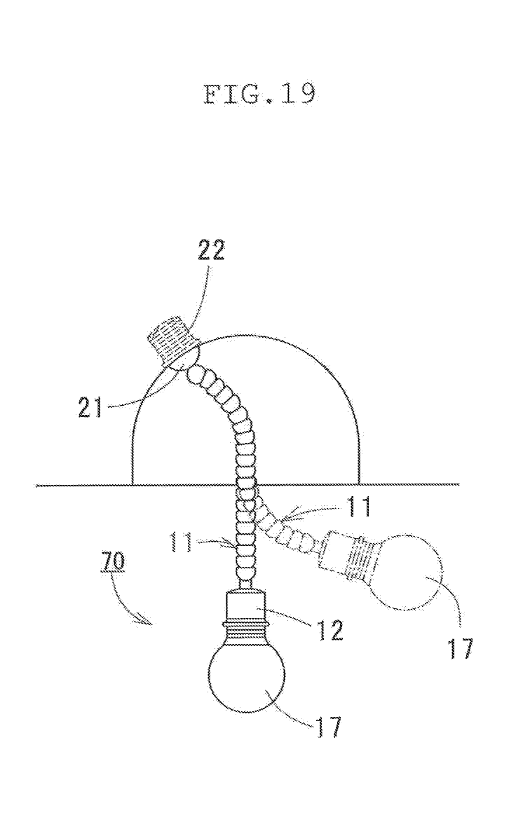

In the bulb mounting fitting 70, the bulb 17 is attached to the bulb socket 12 and the can 21 attached to the end of the cord body 11 is screwed into the power socket 22 fixed to the ceiling as shown in FIG. 19. As a result, the bulb 17 is hung on the cord body 11 connected via the cap 21 to the power socket 22. This can adjust the direction and the height position of the bulb 17 attached to the bulb socket 12 provided on the end of cod body 11 by flexing the cord body 11 in the similar manner as in the bulb mounting fixture 60 according to the sixth embodiment.

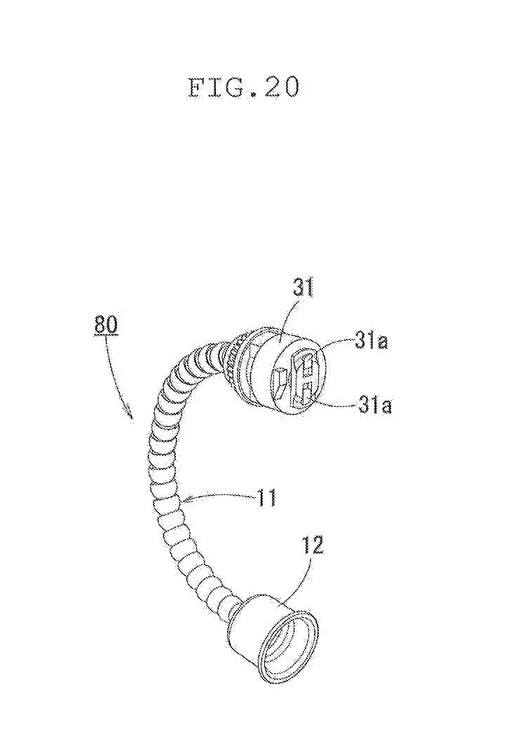

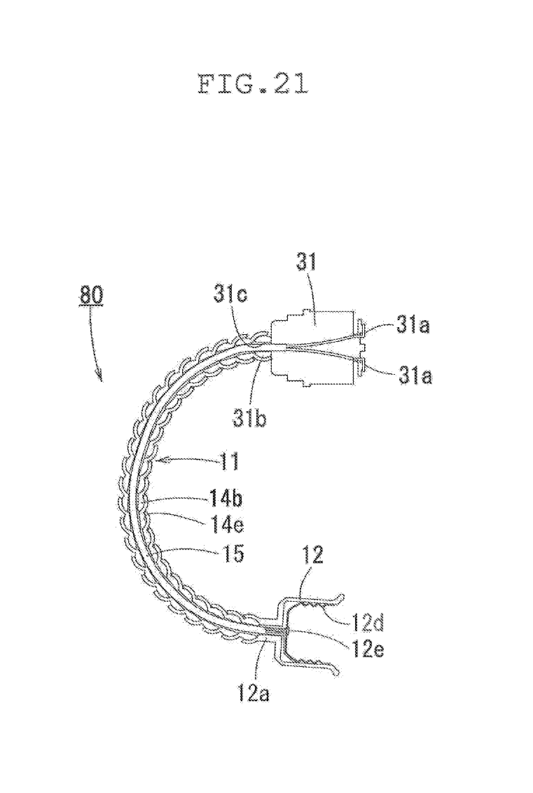

FIGS. 20 to 22 illustrate a bulb mounting fixture 80 according to an eighth embodiment. In the bulb mounting fixture 80, the bulb socket 12 is connected to one end of the cord body 11 and the plug 31 is connected to the other end of the cord body 11. The bulb mounting fixture 80 has the other structure that is the same as that of the bulb mounting fixture 30 according to the third embodiment.

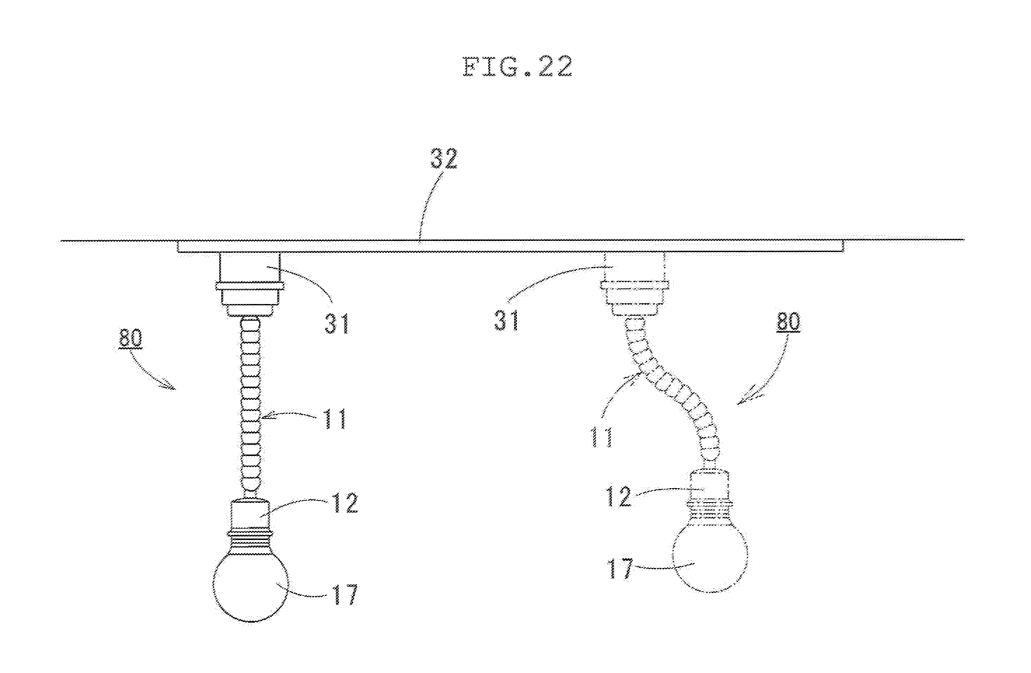

In use of the bulb mounting fixture 80, the plug 31 is connected to the lighting bar 32 and the bulb 17 is attached to the bulb socket 12, as shown in FIG. 22. According to the bulb mounting fixture 80, the position of the bulb 17 hung on the lighting bar 32 can be adjusted along the lighting bar 32. Furthermore, the bulb 17 is attached to the bulb socket 12 provided in the end of the cord body 11. The direction and the height position of the bulb 17 can be adjusted by flexing the cord body 11.

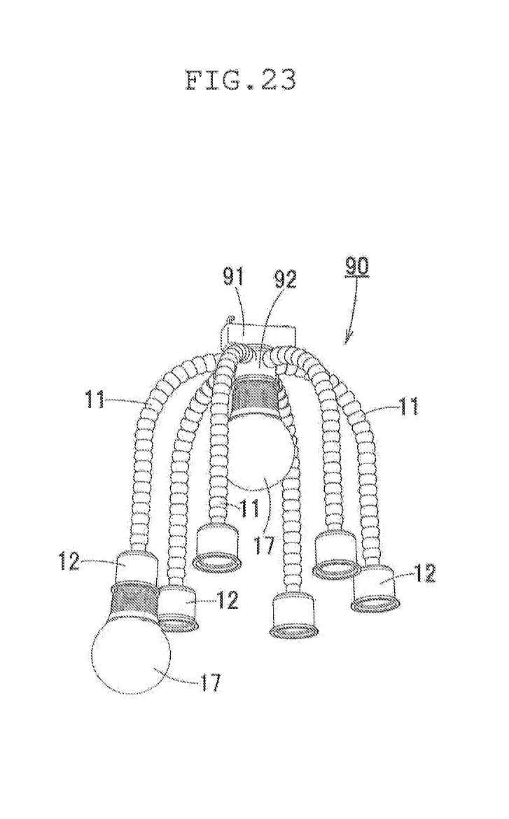

FIG. 23 illustrates a bulb mounting fixture 90 according to a ninth embodiment. In each of the bulb mounting fixtures 60, 70 and 80 according to respective sixth to eighth embodiments, the bulb socket 12 is connected to one end of the cord body 11 and the plug 13 or 31 or the cap 21 is connected to the other end of the cord body 11. In the bulb mounting fixture 90 as shown in FIG. 23, however, a bulb socket 92 is formed integrally on the bottom of a plug 91, and a plurality of cord bodies 11 extends from the peripheral surface of the bulb socket 92. The cord bodies 11 have distal ends to which the bulb sockets 12 are mounted respectively.

According to the bulb mounting fixture 90, the bulbs 17 can be attached to the bulb socket 92 and the bulb sockets 12 respectively. Since positions and directions of the plural bulbs 17 are adjusted by flexing the respective cord bodies 11, the bulb mounting fixture 90 can be used as a decorative lighting with design full of changes.

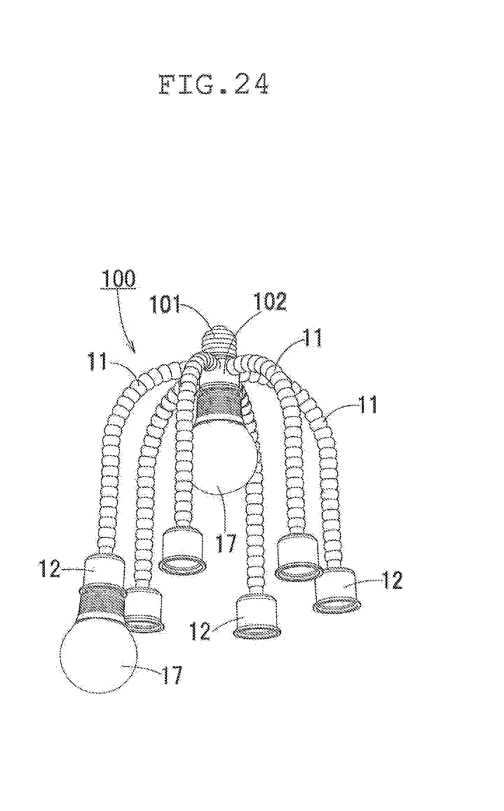

FIG. 24 illustrates a bulb mounting fixture 100 according to a tenth embodiment. The bulb mounting fixture 100 includes a cap 101 having an open end provided with a bulb socket 102. A plurality of cord bodies 11 extends from the peripheral surface of the bulb socket 102. The cord bodies ii have distal ends to which bulb sockets 12 are mounted respectively. The bulbs 17 are attached to the bulb sockets 12 respectively.

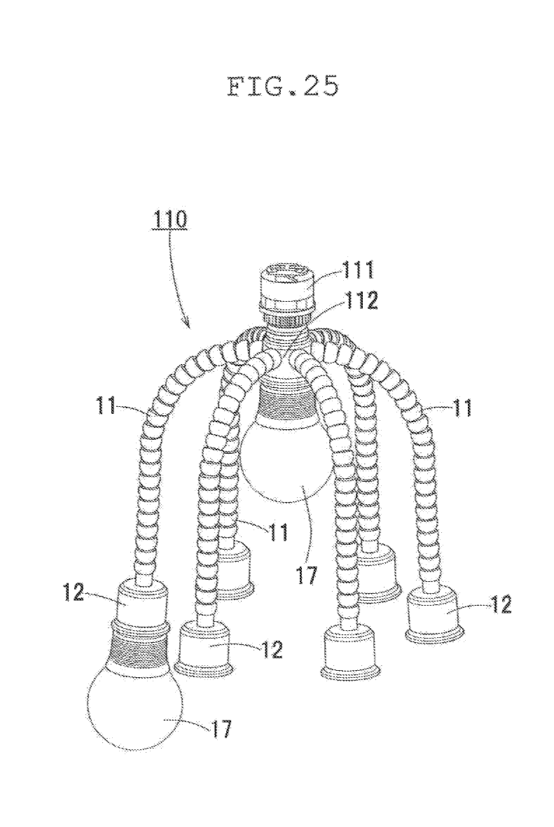

FIG. 25 illustrates a bulb mounting fixture 110 according to an eleventh embodiment. The bulb mounting fixture 110 includes a plug 111 which is to be connected to a lighting bar. The plug 111 has a lower end surface formed with a bulb socket 12 having a peripheral, surface. A plurality of cord bodies 11 extends from the peripheral surface of the bulb socket 112 respectively. The bulb sockets 12 are mounted to the cord bodies 11 respectively. The bulbs 17 can be attached to the bulb sockets 12 and 112 respectively.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A bulb mounting fixture comprising:
a bulb socket to which a cap of an electrical bulb is attachable; and
a plug connectable to an electrical outlet,
wherein the bulb socket and the plug are configured to be connected to each other by a ball joint.

2. A bulb mounting fixture comprising:
a bulb socket to which a cap of an electrical bulb is attachable; and
a cap attachable to a power socket,
wherein the bulb socket and the cap are configured to be connected to each other by a ball joint.

3. The bulb mounting fixture according to claim 1, wherein the bulb socket has a bottom formed with either a male joint having a substantially spherical head and a through hole extending through a central part of the head or a female joint having a substantially semispherical hollow portion and a through hole communicating with the hollow portion;
the plug has a bottom formed with the female joint or the male joint;
the head of the male joint is slidably fitted in the hollow portion of the female joint, whereby the bulb socket and the plug are connected to each other; and
two conductor wires are inserted through the through holes of the male and female joints so that the bulb socket and the plug are electrically connected to each other.

4. The bulb mounting fixture according to claim 1, wherein the bulb socket has a bottom formed with either a male joint having a substantially spherical head and a through hole extending through a central part of the head or a female joint having a substantially semispherical hollow portion and a through hole communicating with the hollow portion;
the cap has a bottom formed with either the female joint or the male joint;
the head of the male joint is slidably fitted in the hollow portion of the female joint, whereby the bulb socket and the plug are connected to each other; and
two conductor wires are inserted through the through holes of the male and female joints so that the bulb socket and the cap are electrically connected to each other.

5. A bulb mounting fixture comprising:
a bulb socket to which a cap of an electrical bulb is attachable;
a plug connectable to an electrical outlet; and
a joint piece,
wherein the bulb socket has a bottom formed with either a first male joint having a substantially spherical head and a through hole extending through a central part of the head or a first female joint having a substantially semispherical hollow portion and a through hole communicating with the hollow portion;
the plug has a bottom formed with either the first female joint or the first male joint;
the joint piece is provided with a second male joint which has a substantially spherical head and a through hole extending through a central part of the head and a second female joint formed integrally on an end of the second male joint located opposite the head and having a substantially semispherical hollow portion which is formed therein so as to communicate with the through hole;
the head of the first male thread joint of either the bulb socket or the plug is slidably fitted in the hollow portion of the second female joint of the joint piece, and the head of the second male joint of the joint piece is slidably fitted in the hollow portion of the first female joint of the plug or the bulb socket, whereby the bulb socket and the plug are connected to each other; and
two conductor wires are inserted through the through holes of the first male and female joints of the bulb socket or the plug and the through hole of the second female joint of the joint piece so that the bulb socket and the plug are electrically connected to each other.

6. A bulb mounting fixture comprising:
a bulb socket to which a cap of an electrical bulb is attachable;
a cap attachable to a power socket; and
a joint piece,
wherein the bulb socket has a bottom formed with a first male joint having a substantially spherical head and a through hole formed through a central part of the head or a first female joint having a substantially semispherical hollow portion and a through hole communicating with the hollow portion;
the cap has a bottom formed with the first male or female joint;
the joint piece is provided with a second male joint which has a substantially spherical head and a through hole extending through a central part of the head and a second female joint formed integrally on an end of the second male joint located opposite the head and having a substantially semispherical hollow portion which is formed therein so as to communicate with the through hole;
the head of the first male thread joint of either the bulb socket or the cap is slidably fitted in the hollow portion of the second female joint of the joint piece, and the head of the second male joint of the joint piece is slidably fitted in the hollow portion of the first female joint of the plug or the bulb socket, whereby the bulb socket and the cap are connected to each other; and
two conductor wires are inserted through the respective through holes of the first male and female joints of the bulb socket or the cap and the through hole of the second female joint of the joint piece so that the bulb socket and the cap are electrically connected to each other.

7. The bulb mounting fixture according to claim 5, wherein a plurality of the joint pieces is provided, and the head of the male joint of one joint piece is slidably fitted in the hollow portion of the other or another joint so that the joint pieces are connected to each other; and
the conductor wires are inserted through the through holes of the connected joint pieces, thereby forming a cord body connecting the bulb socket and the plug to each other.

8. The bulb mounting fixture according to claim 6, wherein a plurality of the joint pieces is provided, and the head of the male joint of one joint piece is slidably fitted in the hollow portion of the other or another joint so that the joint pieces are connected to each other; and
the conductor wires are inserted through the through holes of the connected joint pieces, thereby forming a cord body connecting the bulb socket and the cap to each other.

9. The bulb mounting fixture according to claim 2, wherein the bulb socket and the plug have respective size standards different from each other.

10. The bulb mounting fixture according to claim 6, wherein the bulb socket and the plug have respective size standards different from each other.

11. The bulb mounting fixture according to claim 8, wherein the bulb socket and the plug have respective size standards different from each other.
